(19) United States
(12) Patent Application Publication
(10) Pub. No.: US 2002/0119001 A1
(43) Pub. Date: Aug. 29, 2002

(54) Implement coupling for loading machine

(76) Inventor: Kaj Dam-Rasmussen, Hojbjerg (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/079,406

(22) Filed: Feb. 22, 2002

(30) Foreign Application Priority Data
Feb. 23, 2001 (DK) PA 2001 00308

(51) Int. Cl. F16D 1/00; B25G 3/18

(52) U.S. Cl. 403/322.3

(57) ABSTRACT

There is disclosed an implement coupling for a loading machine including connecting means arranged for mounting the implement coupling at the extreme end of a loading arm and for connecting with an actuating arm of a hydraulic cylinder, the implement coupling comprising coupling means adapted for coupling the implement coupling with complementary coupling means of an implement, e.g. a loading bucket, and a locking mechanism with a transverse, displaceable locking beam comprising locking means adapted for interacting with the complementary coupling means of the implement, and which may be displaced by means of a pivot mechanism and/or a number of spindles or a number of hydraulic cylinders, where the coupling means are constituted by upper fixed hook coupling parts, which are arranged for gripping around upper connecting pins on the implement, and by lower, displacing hook coupling parts, which are arranged for fixing lower connecting pins of the implement when these are in contact with a contact surface on the implement coupling, the displacing coupling parts being connected with the locking beam.

The present invention concerns an implement coupling for a digging or loading machine and of the kind indicated in the preamble of claim 1.

Implement couplings of this kind are used for the purpose of rapidly and easily changing between different implements, e.g. between digging buckets with different widths or between digging and loading buckets. The implement coupling may include a manually operated changing mechanism requiring that the machine operator leaves the operator's cabin, or may comprise a remotely controlled changing mechanism that may be operated from the cabin and which, for example, may comprise a hydraulic cylinder.

The invention has the purpose to provide an implement coupling for a digging or loading machine of the kind mentioned in the introduction, and which by means of simple measures enables achieving good function and extraordinary safety against unintended release of the implement.

The implement coupling according to the invention is peculiar in that the coupling means are constituted by upper fixed hook coupling parts, which are arranged for gripping around upper connecting pins on the implement, and by lower, displacing hook coupling parts, which are arranged for fixing lower connecting pins of the implement when these are in contact with a contact surface on the implement coupling, the displacing coupling parts being connected with the locking beam. By means of simple technical measures there is achieved good function of the implement coupling and extra safety against release of the implement caused by unintended deactivation of the locking function of the implement coupling. It is to be emphasised that the indicated design of the complementary coupling means of implement and implement coupling counteracts difficulties due to relatively often occurring variations in spacing between coupling parts of the implement coupling and connecting pins on the implement.

Suitably, the implement coupling according to the invention may comprise a pivot mechanism arranged to displace the locking beam via a connecting arm, wherein the pivot mechanism comprises an actuation member which is pivotably suspended in the implement coupling, and which is arranged to be pivoted by means of either a mechanical spindle or a hydraulic cylinder, and that the pivot mechanism furthermore is connected with a strong compression spring arranged to bias the locking beam towards its locking position with pressing action.

When the implement coupling according to the invention is adapted for manual operation, it may suitably include at least one mechanical spindle arranged to cause displacing of the locking beam, wherein the locking beam is also connected with a strong compression spring arranged to exert constant pressure on the locking beam so as to bias the beam towards its locking position.

When adapted for hydraulic operation, the implement coupling according to the invention may advantageously include at least one cylinder arranged to cause the displacing of the locking beam, wherein the locking beam furthermore is connected with at least one strong compression spring arranged to exert constant pressure on the locking beam so as to bias the locking beam towards its locking position.

The implement coupling according to the invention may furthermore advantageously be adapted to include a hydraulic cylinder disposed at the centre of implement coupling and arranged to cause the sliding of the locking beam.

Alternatively, the implement coupling according to the invention may furthermore be adapted to include two hydraulic cylinders disposed at each their end of the implement coupling and arranged to cause the displacing of the locking beam.

Furthermore, the implement coupling according to the invention may be designed so that the contact surface of the implement coupling at the side facing the fixed hook coupling part is provided with a projection adapted for facilitating temporary connection between implement coupling and implement until final locking engagement has occurred.

The invention will now be explained in greater detail with reference to the drawing, on which:

FIG. 1 shows a rear view of an embodiment of an implement coupling according to the invention with hydraulic pivoting mechanism,

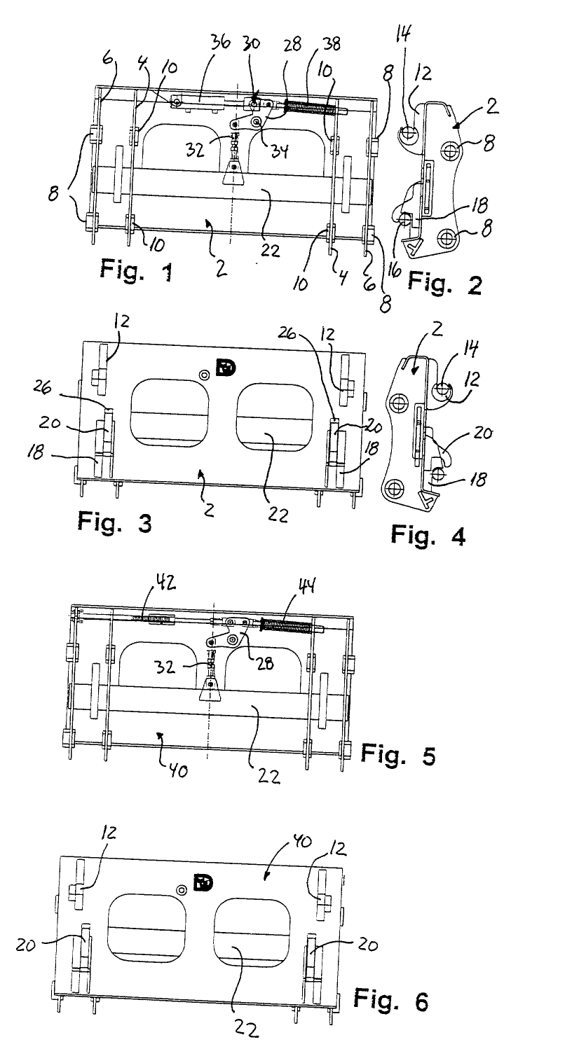

FIG. 2 shows a side view from the left of the implement coupling of FIG. 1 in locked condition,

FIG. 3 shows a front view of the implement coupling of FIG. 1,

FIG. 4 shows a side view from the left of the implement coupling of FIG. 1 in the unlocked condition,

FIG. 5 shows a rear view of a second embodiment of an implement coupling according to the invention with a mechanical pivoting mechanism,

FIG. 6 shows a front view of the implement coupling of FIG. 5,

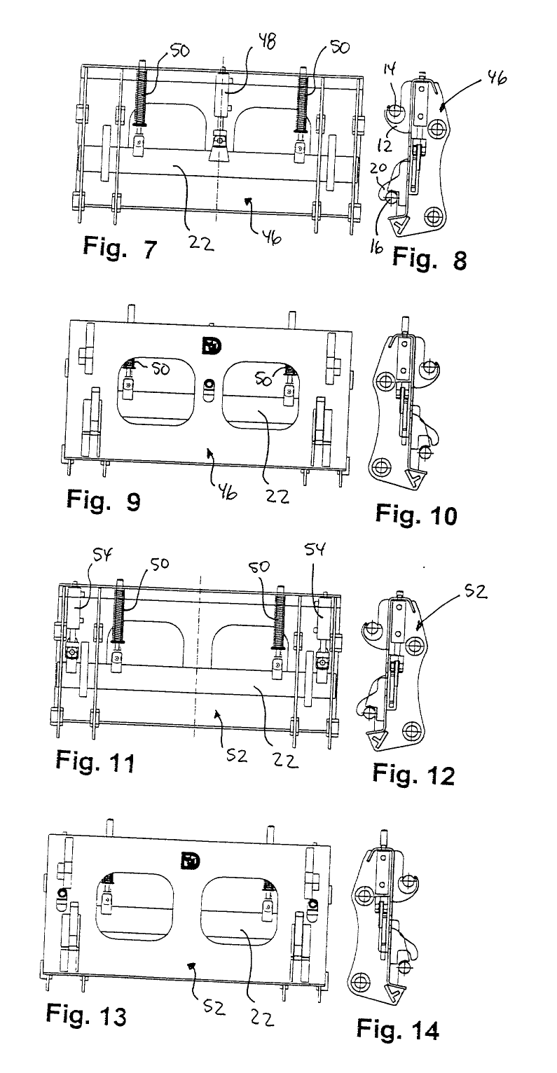

FIG. 7 shows a rear view of a third embodiment of an implement coupling according to the invention with a locking mechanism with one hydraulic cylinder,

FIG. 8 shows a side view from the left of the implement coupling of FIG. 7 in locked condition,

FIG. 9 shows a front view of the implement coupling of FIG. 7,

FIG. 10 shows a side view from the left of the implement coupling of FIG. 9 in unlocked condition,

FIG. 11 shows a rear view of a fourth embodiment of an implement coupling according to the invention with a locking mechanism with two hydraulic cylinders,

FIG. 12 shows a side view from the left of the implement coupling of FIG. 11 in locked condition,

FIG. 13 shows a front view of the implement coupling of FIG. 11,

FIG. 14 shows a side view from the left of the implement coupling of FIG. 13 in unlocked condition,

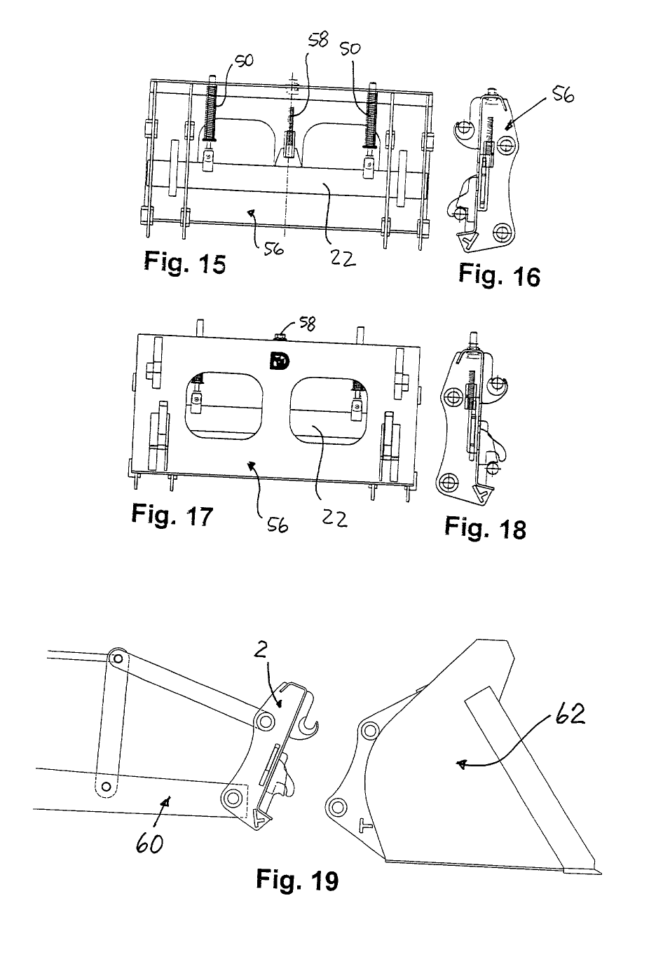

FIG. 15 shows a rear view of a fifth embodiment of an implement coupling according to the invention with one mechanical locking mechanism,

FIG. 16 shows a side view from the left of the implement coupling of FIG. 15 in locked condition,

FIG. 17 shows a front view of the implement coupling of FIG. 15,

FIG. 18 shows a side view from the left of the implement coupling of FIG. 17 in unlocked condition, and

The implement coupling 2 shown in FIGS. 1-4 includes two pairs of parallel bearing plates 4 and 6 with bearing bushes 8 and 10 which serve in mounting the implement coupling 2 at the outer end of a digging or loading arm and serve as a yoke for a hydraulic cylinder for pivoting the implement coupling and implement, respectively, e.g. a digging or loading bucket.

At one side, the implement coupling 2 is provided with hook-shaped connecting parts 12 which are adapted for gripping around fixed connecting pins 14 at each their side of the implement, e.g. a loading bucket which is also provided at the opposite side with connecting pins 16 that are intended for contacting abutments 18 before hook-shaped locking members 20 at opposite ends of a transverse sliding locking beam 22 of the implement coupling 2 are displaced across the connecting pins 16 and fix these against the abutment. At the side facing the hook-shaped connecting parts 12, this has projections 24 with the purpose of facilitating fixation of the implement coupling 2 on the implement until this has been fastened by means of the hook-shaped locking members 20. Compared with previous implement couplings of this kind, which, instead of e.g. abutments 18 and hook-shaped locking members 20, was provided with locking bushings and locking pins, the implement coupling according to the invention is very much easier to use because it allow a certain variation in spacing between the hook-shaped locking members 20 and the abutments 18 without implying extra difficulties by establishing e.g. remotely controlled locking engagement between the implement coupling and an implement, e.g. a digging or loading bucket.

When the hook-shaped connecting parts 12 are brought into position around the connecting pins 14, and the connecting pins 16 are brought into position against the abutments 18, the hook-shaped locking members 20 are displaced across the connecting pins 16, as the locking members 20, which are welded on opposite ends of the locking beam 22, protrude through elongate apertures 26 of the implement coupling 2. This is connected with a pivoting arm 28 of a pivoting mechanism 30 at about the centre of the implement coupling 2 by means of a longitudinally adjustable connecting arm 32.

The pivoting arm 28 is pivotably journalled on the implement coupling 2 about a pivot 34 in such a way that the pivoting arm 28 by pivoting action of a hydraulic cylinder 36 and against the action of a strong compression spring 38 inserted between pivoting arm 28 and one of the bearing plates of the implement coupling may displace the locking beam 22 and the hook-shaped locking members 20 connected therewith in direction away from the abutments 18, i.e. to unlocked condition. This arrangement with compression springs 38 ensures that locked condition can be maintained even though the hydraulic drive pressure disappears.

In FIGS. 5 and 6 is shown another implement coupling 40 constructed like the implement coupling 2 but where the hydraulic cylinder is substituted by a manual spindle mechanism 42 which is able to release the locking engagement between implement coupling 40 and an implement against the action of a compression spring 44.

In FIGS. 7-10 is shown a third implement coupling 46 where the locking engagement between implement and implement coupling 46 is served by one central hydraulic cylinder 48 that can move against the action of two strong compression springs 50 at the withdrawal of the cylinder rod, which is connected with the locking beam and the hook-shaped locking members connected therewith so that the locking engagement between implement and implement coupling is cancelled.

In FIGS. 11-14 is shown a fourth implement coupling 52 where the locking engagement between implement and implement coupling 52 is served by means of two hydraulic cylinders 54 inserted between the implement coupling 52 and the locking beam 22.

In FIGS. 15-18 is shown a fifth implement coupling 56 where the locking engagement between implement and implement coupling 56 is served by means of one central spindle mechanism 58.

1. An implement coupling for a digging or loading machine including connecting means arranged for mounting the implement coupling at the extreme end of a digging or loading arm and for connecting with an actuating arm of a hydraulic cylinder, the implement coupling comprising coupling means adapted for coupling the implement coupling with complementary coupling means of an implement, e.g. a digging or loading bucket, and a locking mechanism with a transverse, displaceable locking beam comprising locking means adapted for interacting with the complementary coupling means of the implement, and which may be displaced by means of a pivot mechanism and/or a number of spindles or a number of hydraulic cylinders, characterized in that the coupling means are constituted by upper fixed hook coupling parts, which are arranged for gripping around upper connecting pins on the implement, and by lower, displacing hook coupling parts, which are arranged for fixing lower connecting pins of the implement when these are in contact with a contact surface on the implement coupling, the displacing coupling parts being connected with the locking beam.

2. An implement coupling according to claim 1 and comprising a pivot mechanism arranged to displace the locking beam via a connecting arm, wherein the pivot mechanism comprises an actuation member which is pivotably suspended in the implement coupling, and which is arranged to be pivoted by means of either a mechanical spindle or a hydraulic cylinder, and wherein the pivot mechanism furthermore is connected with a strong compression spring arranged to bias the locking beam towards its locking position with pressing action.

3. An implement coupling according to claim 1 and comprising at least one mechanical spindle which is arranged to cause the displacing of the locking beam, wherein the locking beam is also connected with a strong compression spring arranged to exert constant pressure on the locking beam so as to bias the beam towards its locking position.

4. An implement coupling according to claim 1 and comprising at least one cylinder arranged to cause the displacing of the locking beam, wherein the locking beam furthermore is connected with at least one strong compression spring arranged to exert constant pressure on the locking beam so as to bias the locking beam towards its locking position.

5. An implement coupling according to claim 4, comprising a hydraulic cylinder disposed at the centre of implement coupling and arranged to cause the displacing of the locking beam.

6. An implement coupling according to claim 4, comprising two hydraulic cylinders disposed at each their end of the implement coupling and arranged to cause the displacing of the locking beam.

7. An implement coupling according to claim 1, wherein the contact surface of the implement coupling at the side facing the fixed, hook coupling part is provided with a projection adapted for facilitating temporary connection between implement coupling and implement until final locking engagement has occurred.
